(19) United States
(12) Patent Application Publication
(10) Pub. No.: US 2026/0211396 A1
(43) Pub. Date: Jul. 23, 2026

(54) METHOD FOR MANUFACTURING INTEGRATED CIRCUITS OF DESIGN LAYOUTS WITH DIFFERENT DENSITIES

(71) Applicant: Shanghai Huahong Grace Semiconductor Manufacturing Corporation, Shanghai (CN)

(72) Inventor: Lei WANG, Shanghai (CN)

(21) Appl. No.: 19/140,396

(22) PCT Filed: Aug. 16, 2023
(86) PCT No.: PCT/CN2023/113291

§ 371 Date: Jun. 18, 2025

(30) Foreign Application Priority Data
Jul. 19, 2023 (CN) 202310891055.5

(51) Int. Cl. G05B 19/4093; H10P 76/00

(52) U.S. Cl. CPC G05B 19/40931; H10P 76/00; G05B 2219/23012

(57) ABSTRACT

This application provides a method for manufacturing integrated circuits of design layouts with different densities, including providing design layouts with different pattern densities of different products, a target density value for the pattern densities of the design layouts, and a corresponding process menu, the pattern density being a ratio of the area occupied by a pattern in a layout to the total area of the layout; adjusting the pattern densities of all design layouts to the target density value to form mask layouts for production; and manufacturing semiconductor devices through the mask layouts by using the same process menu. The final mask layouts for production formed after adjusting the pattern densities for products of design layouts with different pattern densities have the same pattern density, can improve the speed of new product development and large-scale production, can reduce the management difficulty and cost of manufacturing and production.

### TECHNICAL FIELD

This application relates to the field of semiconductor technology, in particular to a method for manufacturing integrated circuits of design layouts with different densities.

### BACKGROUND

The pattern density has a significant influence on critical dimension of lithography, critical dimension of etching, and film formation. Existing layouts usually only control the pattern density within a certain range, such as controlling the active region, gate, and metal interconnect within 20-80%.

Different customer products of the same manufacturing process often have significant differences in pattern density due to different layout designs. Etching and film formation must use different process menus for different customer designs and products. For new customer products, it is necessary to readjust or develop process menus according to different pattern densities. The same equipment has different parameter settings for different process menus. During parameter switching, the equipment needs to be shut down and wait for the switching to be completed. After process parameter switching, a certain period of time is required to stabilize the state of the equipment and calibrate the parameters to ensure that the fluctuations of the new process parameter settings satisfy the requirements of the process fluctuation range. Therefore, switching between different process menus on the same equipment, especially frequent switching, will significantly prolong the waiting time of the equipment, greatly reduce the effective utilization rate of the equipment, and lead to a decrease in production capacity.

To solve the above problems, it is necessary to provide a novel method for manufacturing integrated circuits of design layouts with different densities.

### BRIEF SUMMARY

In view of the disadvantages in the existing technology, the purpose of this application is to provide a method for manufacturing integrated circuits of design layouts with different densities, so as to solve the problems in the existing technology that different customer products of the same manufacturing process often have significant differences in pattern density due to different layout designs, and etching and film formation must use different process menus for different customer designs and products; for new customer products, it is necessary to readjust or develop process menus according to different pattern densities, and the same equipment has different parameter settings for different process menus; during parameter switching, the equipment needs to be shut down and wait for the switching to be completed; after process parameter switching, a certain period of time is required to stabilize the state of the equipment and calibrate the parameters to ensure that the fluctuations of the new process parameter settings satisfy the requirements of the process fluctuation range; therefore, switching between different process menus on the same equipment, especially frequent switching, will significantly prolong the waiting time of the equipment, greatly reduce the effective utilization rate of the equipment, and lead to a decrease in production capacity.

In order to achieve the above purposes and other related purposes, this application provides a method for manufacturing integrated circuits of design layouts with different densities, including:
step 1: providing design layouts with different pattern densities of different products, a target density value for the pattern densities of the design layouts, and a corresponding process menu, the pattern density being a ratio of the area occupied by a pattern in a layout to the total area of the layout;
step 2: adjusting the pattern density of each design layout to the target density value to form mask layouts for production; and
step 3: manufacturing semiconductor devices through the mask layouts by using the same process menu.

Exemplarily, a method for obtaining the target density value and the corresponding process menu includes: designing test masks with different pattern densities; adjusting parameters of test process menus to respectively perform stability tests on each test mask; and selecting the test mask and the test process menu with a stability test result superior to other test groups as the target density value and the corresponding process menu.

Exemplarily, in step 1, the parameters of the process menu corresponding to the target density value are within 10% of the maximum variation range of a manufacturing process.

Exemplarily, in step 1, the target density value satisfies design rules of multi-layer layout stacking.

Exemplarily, in step 2, a method for adjusting the pattern density of each design layout to the target density value to form mask layouts includes:
determining whether the pattern density of each design layout reaches the target density value;
if not, filling the design layout by using a first dummy pattern to enable the pattern density of the design layout to be the target density value, then filling the design layout by using a second dummy pattern to enable the pattern density of the design layout to be the target density value, the first dummy pattern being the same as or similar to a pattern in the design layout, the second dummy pattern being a pattern for circuit matching; and
if so, filling the design layout by using the second dummy pattern to enable the pattern density of the design layout to be the target density value, the dimension of the second dummy pattern being smaller than the dimension of the first dummy pattern, the second dummy pattern being a pattern for circuit matching.

Exemplarily, in step 2, a method for filling the design layout by using a first dummy pattern includes: determining a pattern period of the first dummy pattern, determining a distance between the first pattern and the design layout, and determining a filling range of the first pattern; filling the first pattern on the design layout and determining whether the pattern density of the design layout reaches the target density value;
if so, performing the subsequent step; and
if not, adjusting the pattern period of the first dummy pattern, adjusting the distance between the first pattern and the design layout, adjusting the filling range of the first pattern, and then filling the first pattern on the design layout again till the pattern density of the design layout reaches the target density value.

Exemplarily, in step 2, the cellular unit of the first dummy pattern is an X*Y filling block, and dense filling with the minimum line and gap spacing satisfying design rules is used in the filling.

Exemplarily, in step 2, a method for filling the design layout by using the second dummy pattern includes: determining a pattern period of the second dummy pattern, determining a distance between the second pattern and the design layout, and determining a filling range of the second pattern; filling the second pattern on the design layout and determining whether the pattern density of the design layout reaches the target density value;
if so, performing the subsequent step; and
if not, adjusting the pattern period of the second dummy pattern, adjusting the distance between the second pattern and the design layout, adjusting the filling range of the second pattern, and then filling the first pattern on the design layout again till the pattern density of the design layout reaches the target density value.

Exemplarily, in step 2, the cellular unit of the second dummy pattern is an X*Y rectangle.

Exemplarily, in step 2, a method for adjusting the pattern density of each design layout to the target density value to form mask layouts includes:
filling a first auxiliary pattern in a cutting path pattern area of the design layout; then determining whether the pattern density of the design layout reaches the target density value;
if so, using a layout after filling the first auxiliary pattern as the mask layout; and
if not, filling a blank area in the design layout by using a second auxiliary pattern till the mask layout is obtained.

As described above, the method for manufacturing integrated circuits of design layouts with different densities provided by this application has the following beneficial effects:

This application does not require readjusting or redeveloping process menus for design layouts with different pattern densities of different products of the same manufacturing process. The final mask layouts for production formed after adjusting the pattern densities for products of design layouts with different pattern densities have the same pattern density, are applicable to the same process menu, can improve the speed of new product development and large-scale production, can reduce the management difficulty and cost of manufacturing and production, and can simultaneously improve the manufacturing capacity.

### BRIEF DESCRIPTION OF THE DRAWINGS

FIG. 1 illustrates a flowchart of a process according to this application.

### DETAILED DESCRIPTION OF THE EMBODIMENTS

The embodiments of this application will be described below through specific examples. Those skilled in the art can easily understand the other advantages and effects of this application from the content disclosed in the description. This application can also be implemented or applied through other different specific embodiments. All details in the description may also be modified or changed based on different perspectives and applications without departing from the spirit of this application.

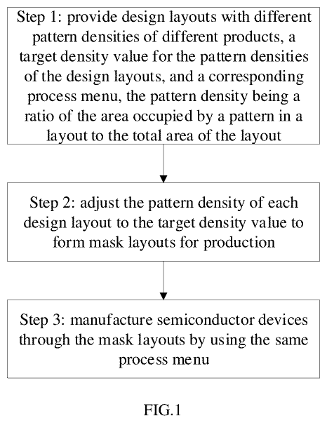

Please refer to FIG. 1. This application provides a method for manufacturing integrated circuits of design layouts with different densities, which includes the following steps:
In step 1, design layouts with different pattern densities of different products, a target density value for the pattern densities of the design layouts, and a corresponding process menu are provided. The pattern density is a ratio of the area occupied by a pattern in a layout to the total area of the layout. The design layouts come from the layouts of different customer products, and the pattern densities thereof often vary greatly. In the existing technology, filling only controls the pattern density within a certain range, such as controlling the active area, gate, and metal interconnect within 20-80%. In this application, the pattern density value is controlled to be a fixed value;

In an alternative embodiment, a method for obtaining the target density value and the corresponding process menu includes: designing test masks with different pattern densities; adjusting parameters of test process menus to respectively perform stability tests on each test mask; and selecting the test mask and the test process menu with a stability test result superior to other test groups as the target density value and the corresponding process menu.

In an alternative embodiment, in step 1, the parameters of the process menu corresponding to the target density value are within 10% of the maximum variation range of a manufacturing process.

In an alternative embodiment, in step 1, the target density value satisfies design rules of multi-layer layout stacking.
In step 2, the pattern density of each design layout is adjusted to the target density value to form mask layouts. That is, by inserting other types of patterns, such as dummy patterns, the pattern densities of the design layouts with different pattern densities can be adjusted to obtain mask layouts with a target density value. The target density value is a preset fixed value. Manufacturing through the mask layouts does not require redeveloping process menus, thus improving the manufacturing capacity. Based on the role of dummy patterns in circuit design and dummy analysis of MOS transistors, in IC layout design, KIA MOS transistors need to not only reflect the logic or functionality of the circuit, ensure correct LVS verification, but also be added with some patterns unrelated to LVS (circuit matching) to reduce the bias in the intermediate process. We usually refer to these patterns as dummy layers.

In an alternative embodiment, in step 2, a method for adjusting the pattern density of each design layout to the target density value to form mask layouts includes:
determining whether the pattern density of each design layout reaches the target density value;
if not, filling the design layout by using a first dummy pattern to enable the pattern density of the design layout to be the target density value, then filling the design layout by using a second dummy pattern to enable the pattern density of the design layout to be the target density value, the first dummy pattern being the same as or similar to a pattern in the design layout, the second dummy pattern being a pattern for circuit matching; and
if so, filling the design layout by using the second dummy pattern to enable the pattern density of the design layout to be the target density value, the dimension of the second dummy pattern being smaller than the dimension of the first dummy pattern, the second dummy pattern being a pattern for circuit matching.

In an alternative embodiment, in step 2, a method for filling the design layout by using a first dummy pattern includes: determining a pattern period of the first dummy pattern, determining a distance between the first pattern and the design layout, and determining a filling range of the first pattern; filling the first pattern on the design layout and determining whether the pattern density of the design layout reaches the target density value;
if so, performing the subsequent step; and
if not, adjusting the pattern period of the first dummy pattern, adjusting the distance between the first pattern and the design layout, adjusting the filling range of the first pattern, and then filling the first pattern on the design layout again till the pattern density of the design layout reaches the target density value.

In an alternative embodiment, in step 2, the cellular unit of the first dummy pattern is an X*Y filling block, and dense filling with the minimum line and gap spacing satisfying design rules is used in the filling.

In an alternative embodiment, in step 2, a method for filling the design layout by using the second dummy pattern includes: determining a pattern period of the second dummy pattern, determining a distance between the second pattern and the design layout, and determining a filling range of the second pattern; filling the second pattern on the design layout and determining whether the pattern density of the design layout reaches the target density value;
if so, performing the subsequent step; and
if not, adjusting the pattern period of the second dummy pattern, adjusting the distance between the second pattern and the design layout, adjusting the filling range of the second pattern, and then filling the first pattern on the design layout again till the pattern density of the design layout reaches the target density value.

In an alternative embodiment, in step 2, the cellular unit of the second dummy pattern is an X*Y rectangle.

In an alternative embodiment, in step 2, a method for adjusting the pattern density of each design layout to the target density value to form mask layouts includes:
filling a first auxiliary pattern in a cutting path pattern area of the design layout; then determining whether the pattern density of the design layout reaches the target density value;
if so, using a layout after filling the first auxiliary pattern as the mask layout; and
if not, filling a blank area in the design layout by using a second auxiliary pattern till the mask layout is obtained.

It should be noted that in step 2, other methods well-known to those skilled in the art may be used to adjust the pattern density of each design layout to the target density value to form mask layouts, which are not specifically limited here.

In step 3, semiconductor devices are manufactured through the mask layouts by using the same process menu. After adjusting the pattern densities, the same process menu is applicable to products with different pattern densities, the management difficulty of manufacturing and production is reduced, and the manufacturing capacity is improved.

It should be noted that the drawings provided in this embodiment are only used for schematically describing the basic concept of this application, thus only show the components related to this application, and are not drawn according to the actual numbers, shapes and sizes of the components during implementation. The configuration, number and scale of each component may be freely changed during actual implementation, and the component layout may also be more complex.

To sum up, this application does not require readjusting or redeveloping process menus for design layouts with different pattern densities of different products of the same manufacturing process. The final mask layouts for production formed after adjusting the pattern densities for products of design layouts with different pattern densities have the same pattern density, are applicable to the same process menu, can improve the speed of new product development and large-scale production, can reduce the management difficulty and cost of manufacturing and production, and can simultaneously improve the manufacturing capacity. Therefore, this application effectively overcomes various disadvantages in the existing technology and thus has a great industrial utilization value.

The above embodiments only exemplarily describe the principle and effect of this application, and are not intended to limit this application. Those skilled in the art may modify or change the above embodiments without departing from the spirit and scope of this application. Therefore, all equivalent modifications or changes made by those skilled in the art without departing from the spirit and technical concept disclosed in this application shall still be covered by the claims of this application.

1. A method for manufacturing integrated circuits of design layouts with different densities, at least comprising:
step 1: providing design layouts with different pattern densities of different products, a target density value for the pattern densities of the design layouts, and a corresponding process menu, the pattern density being a ratio of the area occupied by a pattern in a layout to the total area of the layout;
step 2: adjusting the pattern density of each design layout to the target density value to form mask layouts for production; and
step 3: manufacturing semiconductor devices through the mask layouts by using the same process menu.

2. The method for manufacturing integrated circuits of design layouts with different densities according to claim 1, wherein in step 1, a method for obtaining the target density value and the corresponding process menu comprises: designing test masks with different pattern densities; adjusting parameters of test process menus to respectively perform stability tests on each test mask; and selecting the test mask and the test process menu with a stability test result superior to other test groups as the target density value and the corresponding process menu.

3. The method for manufacturing integrated circuits of design layouts with different densities according to claim 2, wherein in step 1, the parameters of the process menu corresponding to the target density value are within 10% of the maximum variation range of a manufacturing process.

4. The method for manufacturing integrated circuits of design layouts with different densities according to claim 1, wherein in step 1, the target density value satisfies design rules of multi-layer layout stacking.

5. The method for manufacturing integrated circuits of design layouts with different densities according to claim 1, wherein in step 2, a method for adjusting the pattern density of each design layout to the target density value to form mask layouts comprises:
determining whether the pattern density of each design layout reaches the target density value;
if not, filling the design layout by using a first dummy pattern to enable the pattern density of the design layout to be the target density value, then filling the design layout by using a second dummy pattern to enable the pattern density of the design layout to be the target density value, the first dummy pattern being the same as or similar to a pattern in the design layout, the second dummy pattern being a pattern for circuit matching; and
if so, filling the design layout by using the second dummy pattern to enable the pattern density of the design layout to be the target density value, the dimension of the second dummy pattern being smaller than the dimension of the first dummy pattern, the second dummy pattern being a pattern for circuit matching.

6. The method for manufacturing integrated circuits of design layouts with different densities according to claim 5, wherein in step 2, a method for filling the design layout by using a first dummy pattern comprises: determining a pattern period of the first dummy pattern, determining a distance between the first pattern and the design layout, and determining a filling range of the first pattern; filling the first pattern on the design layout and determining whether the pattern density of the design layout reaches the target density value;
if so, performing the subsequent step; and
if not, adjusting the pattern period of the first dummy pattern, adjusting the distance between the first pattern and the design layout, adjusting the filling range of the first pattern, and then filling the first pattern on the design layout again till the pattern density of the design layout reaches the target density value.

7. The method for manufacturing integrated circuits of design layouts with different densities according to claim 1, wherein in step 2, the cellular unit of the first dummy pattern is an X*Y filling block, and dense filling with the minimum line and gap spacing satisfying design rules is used in the filling.

8. The method for manufacturing integrated circuits of design layouts with different densities according to claim 5, wherein in step 2, a method for filling the design layout by using the second dummy pattern comprises: determining a pattern period of the second dummy pattern, determining a distance between the second pattern and the design layout, and determining a filling range of the second pattern; filling the second pattern on the design layout and determining whether the pattern density of the design layout reaches the target density value;
if so, performing the subsequent step; and
if not, adjusting the pattern period of the second dummy pattern, adjusting the distance between the second pattern and the design layout, adjusting the filling range of the second pattern, and then filling the first pattern on the design layout again till the pattern density of the design layout reaches the target density value.

9. The method for manufacturing integrated circuits of design layouts with different densities according to claim 8, wherein in step 2, the cellular unit of the second dummy pattern is an X*Y rectangle.

10. The method for manufacturing integrated circuits of design layouts with different densities according to claim 1, wherein in step 2, a method for adjusting the pattern density of each design layout to the target density value to form mask layouts comprises:
filling a first auxiliary pattern in a cutting path pattern area of the design layout; then determining whether the pattern density of the design layout reaches the target density value;
if so, using a layout after filling the first auxiliary pattern as the mask layout; and
if not, filling a blank area in the design layout by using a second auxiliary pattern till the mask layout is obtained.
